(19) United States
(12) Patent Application Publication
(10) Pub. No.: US 2010/0177051 A1
(43) Pub. Date: Jul. 15, 2010

(54) TOUCH DISPLAY RUBBER-BAND GESTURE

(75) Inventor: Charles Bilow, North Bend, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/353,888

(22) Filed: Jan. 14, 2009

(51) Int. Cl. G06F 3/041; A63F 9/24

(52) U.S. Cl. 345/173; 463/36

(57) ABSTRACT

A rubber-band gesture begins with a source touching a touch display at a touch-down location of the touch display. The rubber-band gesture continues until the source stops touching the touch display at a lift-up location of the touch display. An action is displayed on the touch display in response to the rubber-band gesture. The action is displayed in a direction parallel to a vector pointing from the lift-up location to the touch-down location. The action is displayed with an action amplitude derived from a distance from the touch-down location to the lift-up location.

### BACKGROUND

A touch display is a display that serves the dual function of visually presenting information and receiving user input. Touch displays may be utilized with a variety of different devices to provide a user with an intuitive input mechanism that can be directly linked to information visually presented by the touch display. A user may use touch input to push soft buttons, turn soft dials, size objects, orientate objects, or perform a variety of different inputs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A rubber-band gesture for controlling a touch display is disclosed. The rubber-band gesture begins with a source touching the touch display at a touch-down location of the touch display. The rubber-band gesture continues until the source stops touching the touch display at a lift-up location of the touch display. An action is displayed on the touch display in response to the rubber-band gesture. The action is displayed in a direction parallel to a vector pointing from the lift-up location to the touch-down location. The action is displayed with an action amplitude derived from a distance from the touch-down location to the lift-up location.

### BRIEF DESCRIPTION OF THE DRAWINGS

FIG. 1 shows a plurality of users performing rubber-band gestures on a touch display in accordance with an embodiment of the present disclosure.

FIG. 2 shows an example method of operating a computing device having a touch display in accordance with the present disclosure.

FIG. 3 shows an action being carried out in response to a rubber-band gesture.

FIG. 4 shows another action being carried out in response to a rubber-band gesture.

FIG. 5 shows two different actions being carried out in response to temporally overlapping rubber-band gestures.

FIG. 6 schematically shows a computing device in accordance with the present disclosure.

### DETAILED DESCRIPTION

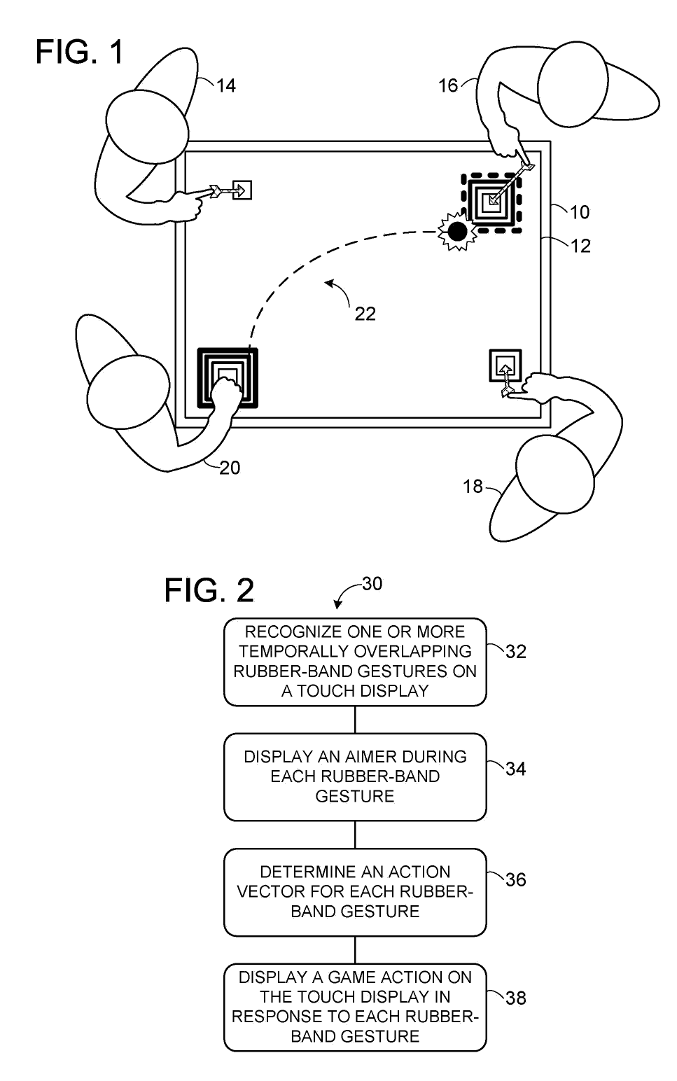

FIG. 1 somewhat schematically shows a computing device 10. Computing device 10 includes a touch display 12 that is configured to visually present images to a user (e.g., user 14, user 16, user 18, and/or user 20) and to receive and process touch input from the user. In the illustrated embodiment, computing device 10 takes the form of a surface computing device. However, it is to be understood that the present disclosure is not limited to surface computing devices. The herein disclosed methods and processes may be implemented on virtually any computing system having a touch display.

Computing device 10 is shown visually presenting a game 22 in which each user controls a tower that is capable of shooting cannonballs at towers controlled by other users. In particular, the users are utilizing a rubber-band gesture as a form of input to control the firing of cannonballs at the towers of their opponents. While the firing of cannonballs provides an example use of a rubber-band gesture, such a use should not be considered in a limiting sense. A rubber-band gesture may be used to perform of a variety of different actions on a computing system that utilizes a touch display. While described here in the context of a cannonball game, it is to be understood that a touch display may visually present a variety of different games and/or other types of operating environments. The herein described rubber-band gestures can be used to operate virtually any type of computing device including a touch display.

Turning to FIG. 2, an example method 30 of operating a computing device having a touch display is shown. At 32, method 30 includes recognizing one or more gestures on a touch display. When two or more gestures are recognized, such gestures may be temporally overlapping gestures. A rubber-band gesture may be performed by a source, such as a finger, a stylus, a fist, a blob, or another suitable object. The rubber-band gesture may be recognized in a variety of different ways depending on the type of touch display being used. As an example, the touch display may be a capacitive touch screen, in which case recognizing a gesture may include recognizing a change in capacitance of the touch display. As another example, the touch display may be part of a surface computing device that uses infrared light to track user input, in which case recognizing a gesture may include recognizing a change in an amount of infrared light reflecting from a surface of the touch display. Other touch computing systems may recognize gestures in a different manner without departing from the scope of this disclosure. Furthermore, one gesture may be distinguished from other gestures by the physical (e.g., electrical, optical, mechanical) changes in the touch display. In this way, a gesture can be analyzed to determine if it satisfies predetermined criteria for a rubber-band gesture.

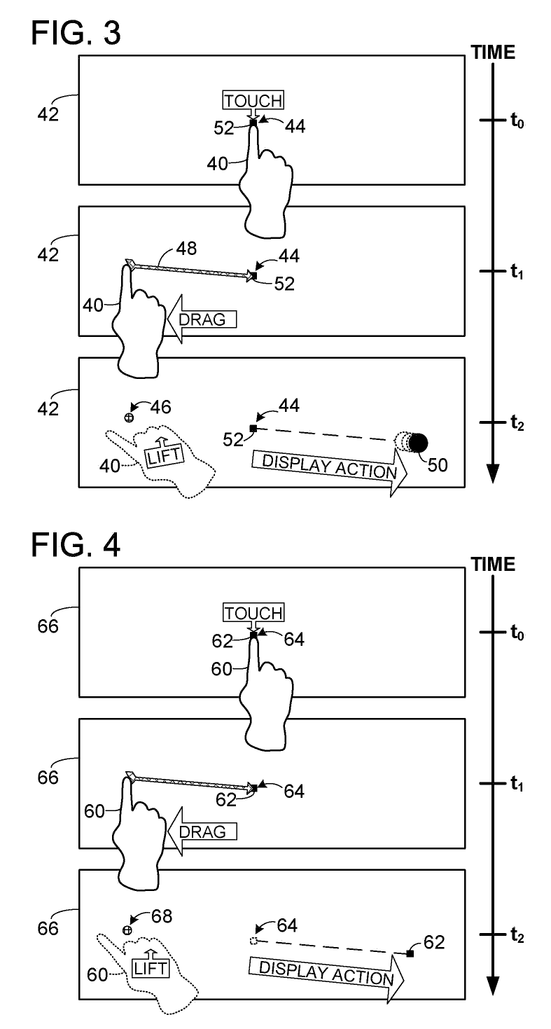

FIG. 3 shows a finger 40 performing an exemplary rubber-band gesture that can be recognized by a computing device including a touch display. At time t₀, the rubber-band gesture begins with a finger 40 touching a touch display 42 at a touch-down location 44. At time t₁, the rubber-band gesture continues with finger 40 dragging across touch display 42. The rubber-band gesture continues until the finger stops touching the touch display at a lift-up location 46, as shown at time t₂. Also shown at time t₂, the rubber-band gesture can be used to bring about an action that can be displayed on touch display 42.

A rubber-band gesture is analogous to the loading and shooting of a rubber band. The dragging of finger 40 away from touch-down location 44 is analogous to the stretching of a rubber band. The distance finger 40 drags away from touch-down location 44 is analogous to the degree to which the rubber band is stretched. The relative positioning of lift-up location 46 to touch-down location 44 is analogous to the direction in which a stretched rubber band is being aimed. As described below, a rubber-band gesture can be used to effectuate virtually any action that has a variable amplitude and a variable direction. Much like a rubber band can be shot in a variety of different directions with a variety of different velocities (depending on how far the rubber band is stretched before it is shot), actions resulting from rubber-band gestures can be carried out in a variety of different directions with a variety of different amplitudes.

Turning back to FIG. 2, at 34, method 30 includes displaying an aimer during the rubber-band gesture. The aimer may visually indicate an amplitude and a direction with which a subsequent action will be carried out as a result of the completed rubber band-gesture. In some embodiments, the aimer may visually indicate a same amplitude as an action vector, described hereafter. In other embodiments, the aimer may visually indicate a same amplitude as a resulting action, or some other distance that is mathematically related to the action vector, so that when the gesture distance changes, the amplitude of the action vector changes and likewise, the amplitude of the aimer displayed on the screen also changes.

At time t₁, FIG. 3 shows a nonlimiting example of an aimer 48 in the context of a cannonball game. In this example, aimer 48 visually indicates the direction and the range a cannonball will be launched in response to the rubber-band gesture. The direction at which the cannonball will be launched can be indicated by the direction to which aimer 48 points. The range at which the cannonball will be launched can be indicated by a length of aimer 48. It is to be understood, however, that aimer 48 is provided as a nonlimiting example. Other aimers may indicate range, or another type of amplitude, numerically, using a color, with audio feedback, or in virtually any other suitable manner. Likewise, aimers may indicate direction in any suitable manner. In some embodiments, the amplitude and direction may be indicated by a common visual element, such as an arrow of variable length, or a bullseye that hovers over an intended target of the action.

A user may change the amplitude or the direction of an action by moving a source (e.g., finger) to a different area of the touch display before lifting the source and ending the rubber-band gesture. As the user moves the source, the aimer provides visual feedback as to how the amplitude (e.g., range) and/or the direction (e.g., aim) changes. Because the rubber-band gesture does not end until a user stops touching the touch display, a user can take considerable care while aiming and/or setting the amplitude of the action that will result from the completed rubber-band gesture. An aimer may assist a user in achieving an intended amplitude and/or direction of the resulting action. On the other hand, a user may execute the rubber-band gesture relatively quickly, choosing speed with the chance of sacrificing at least some accuracy.

Turning back to FIG. 2, at 36, method 30 includes determining an action vector. The action vector has a vector direction pointing from the lift-up location to the touch-down location and a vector magnitude equal to a distance from the lift-up location to the touch-down location. The action vector can be embodied as a data structure on which a computing system may operate. Such a data structure represents real world parameters of the rubber-band gesture, and allows different logic to be applied to the real world parameters when determining how an action should be carried out in response to the rubber-band gesture.

At 38, method 30 includes displaying a game action on the touch display in response to the rubber-band gesture. A variety of different game actions can be displayed in response to a rubber-band gesture without departing from the scope of this disclosure. As a nonlimiting example, as shown in FIG. 3, the game action can be the firing of a projectile. In particular, at time t₂, FIG. 3 shows a cannonball 50 being fired from a tower 52 positioned at touch-down location 44. The cannonball 50 is fired at a range corresponding to the relative distance between touch-down location 44 and lift-up location 46. In other words, the game action has an amplitude derived from the vector magnitude determined at 36 of method 30. Further, the cannonball is fired in a direction parallel to a vector pointing from the lift-up location to the touch-down location. In other words, the game action proceeds in the vector direction determined at 36 of method 30.

In some embodiments, the game action originates at a game object on the touch display. Further, in some embodiments, the game action is the moving of the game object. As an example, FIG. 4 shows a rubber-band gesture being used to move a game object. At time t₀, a finger 60 begins a rubber-band gesture by touching a game object 62 at a touch-down location 64 of a touch display 66. At time t₁, finger 60 drags away from touch-down location 64. At time t₂, finger 60 ends the rubber-band gesture by lifting from touch display 66 at a lift-up location 68. As a result of this rubber-band gesture, game object 62 is moved in a vector direction pointing from lift-up location 68 to touch-down location 64. Further, game object 62 is moved a distance derived from a distance from lift-up location 68 to touch-down location 64.

The firing of a projectile and the moving of an object are two nonlimiting examples of actions that can be carried out responsive to a rubber-band gesture. Virtually any action that has a variable amplitude and/or a variable direction can be carried out responsive to a rubber-band gesture.

In some embodiments, an action can originate from any location on a touch display. In other embodiments, an action is constrained to originate from a finite number of predetermined locations, which may correspond to where certain objects are located. As an example, a cannonball may only be fired from a tower in a cannonball game. In such scenarios, the touch-down location can automatically be set to a predetermined location.

The amplitude of an action resulting from a rubber-band gesture can be derived from a distance between the touch-down location and the lift-up location of the rubber-band gesture (i.e., the gesture distance), which may be embodied in a vector magnitude as discussed with reference to 36 of FIG. 2. In particular, the amplitude of the resulting action and the gesture distance can be determined by a predetermined relationship. In some embodiments, the amplitude of the action can equal the gesture distance. For example, a cannonball may be fired at a range that equals the gesture distance. In other embodiments, the amplitude may be linearly related to the gesture distance. For example, a cannonball may be fired twice as far as the gesture distance, or the cannonball may be fired three times as far as the gesture distance. In other embodiments, the amplitude may be nonlinearly related to the gesture distance. For example, the action amplitude may exponentially increase as the gesture distance increases.

Two or more rubber-band gestures can be performed at the same time (i.e., temporally overlapping rubber-band gestures). Computing devices in accordance with the present disclosure can be configured to recognize a plurality of temporally overlapping rubber-band gestures on the touch display, and for each recognized rubber-band gesture, determine a corresponding action vector and display a corresponding game action.

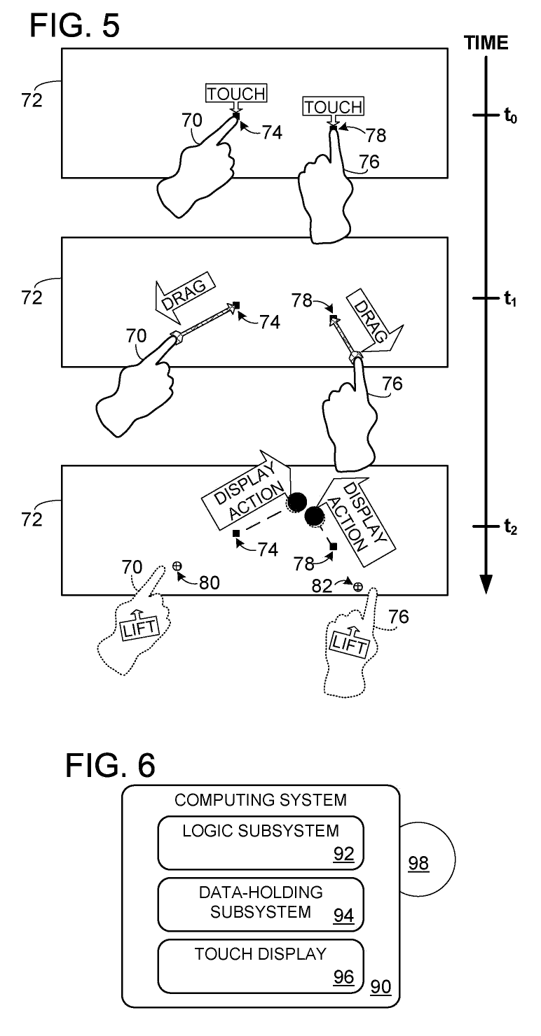

For example, at time t₀, FIG. 5 shows a first finger 70 beginning a first rubber-band gesture by touching touch display 72 at a first touch-down location 74. Also at time t₀, FIG. 5 shows a second finger 76 beginning a second rubber-band gesture by touching touch display 72 at a second touch-down location 78. At time t₁, first finger 70 drags away from first touch-down location 74, and second finger 76 drags away from second touch-down location 78. At time t₂, first finger 70 ends the first rubber-band gesture by lifting from touch display 72 at a first lift-up location 80, and second finger 76 ends the second rubber-band gesture by lifting from touch display 72 at a second lift-up location 82. As a result of these temporally overlapping rubber-band gestures, two different actions are carried out, as shown at time t₂ of FIG. 5. If the ending of the rubber-band gestures are sufficiently close, the resulting actions may also be temporally overlapping.

It should be understood that a computing device may be configured to recognize virtually any number of temporally overlapping rubber-band gestures. Temporally overlapping rubber-band gestures may be performed by a single user. For example, a user may use both and/or two or more fingers from the same hand to perform temporally overlapping gestures. Temporally overlapping rubber-band gestures may additionally or alternatively be performed by two or more different users.

In some embodiments, a computing device can be configured to differentiate between two or more different sources performing the different temporally overlapping rubber-band gestures. For example, returning to the scenario shown in FIG. 1, a particular user may be rewarded points for shooting another user's tower with a cannonball. As such, a computing device may be configured to determine which user is performing the rubber-band gesture responsible for the shooting of a tower. A particular user may be identified by the area of the touch display on which the rubber-band gesture is performed, the orientation of the user's finger, be reading a marker or other indicator assigned to the user, or by any other suitable means. In some embodiments, a computing device may determine a consequence that is dependent on a source performing the rubber-band gesture. Using the above scenario, a computing device may attribute points to a particular user when that user successfully hits another tower with a cannonball. For example, as depicted in FIG. 1, user 20 may be awarded points for shooting the tower of user 16. The above cannonball scenario is a nonlimiting example, and source differentiation and/or consequence attribution may be implemented in many other ways.

In some embodiments, the above described methods and processes may be tied to a computing system. As an example, FIG. 6 schematically shows a computing system 90 that may perform one or more of the above described methods and processes. Computing system 90 includes a logic subsystem 92, a data-holding subsystem 94, a touch display 96, and optionally other components not shown in FIG. 6. Computing system 90 may be a surface computer, tablet computer, mobile communications device, personal data assistant, desktop computer with a touch screen, laptop computer with a touch screen, or virtually any other computing device that utilizes a touch display.

Logic subsystem 92 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 94 may include one or more physical devices configured to hold data and/or instructions executable by the logic subsystem to implement the herein described methods and processes. When such methods and processes are implemented, the state of data-holding subsystem 94 may be transformed (e.g., to hold different data). Data-holding subsystem 94 may include removable media and/or built-in devices. Data-holding subsystem 94 may include optical memory devices, semiconductor memory devices, and/or magnetic memory devices, among others. Data-holding subsystem 94 may include devices with one or more of the following characteristics: volatile, nonvolatile, dynamic, static, read/write, read-only, random access, sequential access, location addressable, file addressable, and content addressable. In some embodiments, logic subsystem 92 and data-holding subsystem 94 may be integrated into one or more common devices, such as an application specific integrated circuit or a system on a chip.

FIG. 6 also shows an aspect of the data-holding subsystem in the form of computer-readable removable media 98, which may be used to store and/or transfer data and/or instructions executable to implement the herein described methods and processes.

Touch display 96 may be used to present a visual representation of data held by data-holding subsystem 94. As the herein described methods and processes change the data held by the data-holding subsystem, and thus transform the state of the data-holding subsystem, the state of touch display 96 may likewise be transformed to visually represent changes in the underlying data. Touch display 96 may be combined with logic subsystem 92 and/or data-holding subsystem 94 in a shared enclosure, or touch display 96 may be a peripheral display device.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A gaming system, comprising:
a touch display;
a logic subsystem operatively coupled to the touch display; and
a data-holding subsystem holding instructions executable by the logic subsystem to:
recognize a rubber-band gesture on the touch display, the rubber-band gesture beginning with a source touching the touch display at a touch-down location of the touch display and continuing until the source stops touching the touch display at a lift-up location of the touch display;
determine an action vector having a vector direction pointing from the lift-up location to the touch-down location and a vector magnitude equal to a distance from the lift-up location to the touch-down location; and
display a game action on the touch display, the game action originating at a game object on the touch display and proceeding in the vector direction with an action amplitude derived from the vector magnitude.

2. The gaming system of claim 1, where the game action is the firing of a projectile from the game object in the vector direction with a range derived from the vector magnitude.

3. The gaming system of claim 1, where the game action is a moving of the game object in the vector direction with a range derived from the vector magnitude.

4. The gaming system of claim 1, where the data-holding subsystem holds instructions executable by the logic subsystem to display an aimer during the rubber-band gesture, the aimer visually indicating the vector direction and the action amplitude.

5. The gaming system of claim 1, where the data-holding subsystem holds instructions executable by the logic subsystem to recognize a plurality of temporally overlapping rubber-band gestures on the touch display, and for each recognized rubber-band gesture, determine a corresponding action vector and display a corresponding game action.

6. The gaming system of claim 5, where the data-holding subsystem holds instructions executable by the logic subsystem to differentiate between two or more different sources performing the plurality of temporally overlapping rubber-band gestures.

7. The gaming system of claim 6, where the data-holding subsystem holds instructions executable by the logic subsystem to determine a game consequence that is dependent on a source performing the rubber-band gesture.

8. The gaming system of claim 1, where the action amplitude is linearly related to the vector magnitude.

9. The gaming system of claim 1, where the action amplitude is nonlinearly related to the vector magnitude.

10. A method of operating a computing device having a touch display, the method comprising:
recognizing a gesture on the touch display, the gesture including a touch-down location and a lift-up location;
displaying an action on the touch display in response to the gesture, the action displayed in a direction parallel to a vector pointing from the lift-up location to the touch-down location and the action displayed with an action amplitude derived from a distance from the lift-up location to the touch-down location.

11. The method of claim 10, where the action is a firing of a projectile from the touch-down location in a direction parallel to a vector pointing from the lift-up location to the touch-down location with a range related to the distance from the touch-down location to the lift-up location.

12. The method of claim 10, where the action is the moving of an object from the touch-down location in a direction parallel to a vector pointing from the lift-up location to the touch-down location with a range related to the distance from the touch-down location to the lift-up location.

13. The method of claim 10, further comprising displaying an aimer while the gesture is being performed, the aimer visually indicating a direction and an amplitude with which the action is to be displayed.

14. The method of claim 10, where the gesture is one of a plurality of temporally overlapping gestures, and where the method further comprises recognizing each temporally overlapping gesture and displaying a corresponding action for each temporally recognized gesture.

15. The method of claim 14, further comprising differentiating between two or more different sources performing the plurality of temporally overlapping gestures.

16. The method of claim 15, further comprising determining a game consequence that is dependent on a source performing the gesture.

17. The method of claim 10, where the action amplitude is linearly related to the distance from the touch-down location to the lift-up location.

18. The method of claim 10, where the action amplitude is nonlinearly related to the distance from the touch-down location to the lift-up location.

19. A method of operating a gaming device having a touch display, the method comprising:
recognizing a first rubber-band gesture on the touch display, the first rubber-band gesture beginning with a first source touching the touch display at a first touch-down location of the touch display and continuing until the first source stops touching the touch display at a first lift-up location of the touch display;
recognizing a second rubber-band gesture on the touch display, the second rubber-band gesture beginning with a second source touching the touch display at a second touch-down location of the touch display and continuing until the second source stops touching the touch display at a second lift-up location of the touch display;
determining a first action vector having a first vector direction pointing from the first lift-up location to the first touch-down location and a first vector magnitude equal to a distance from the first lift-up location to the first touch-down location;
determining a second action vector having a second vector direction pointing from the second lift-up location to the second touch-down location and a second vector magnitude equal to a distance from the second lift-up location to the second touch-down location;
displaying a first game action on the touch display, the first game action displayed in the first vector direction with a first action amplitude related to the first vector magnitude; and
displaying a second game action on the touch display, the second game action displayed in the second vector direction with a second action amplitude related to the second vector magnitude

20. The method of claim 19, where the first rubber-band gesture and the second rubber-band gesture temporally overlap.
